(19) United States
(12) Patent Application Publication
(10) Pub. No.: US 2018/0043269 A1
(43) Pub. Date: Feb. 15, 2018

(54) SYSTEMS AND METHODS FOR INTERACTIVE GRAPHICS GAME AND APPLICATION OBJECTS IN AN INSTANT MESSAGING SESSION

(71) Applicant: Yio-Chian Tao, Saratoga, CA (US)

(72) Inventor: Yio-Chian Tao, Saratoga, CA (US)

(21) Appl. No.: 15/237,523

(22) Filed: Aug. 15, 2016

(51) Int. Cl. A63F 13/87; G07F 17/32; A63F 13/73; A63F 13/92; A63F 13/25; A63F 13/335

(52) U.S. Cl. CPC A63F 13/87; A63F 13/25; A63F 13/335; A63F 13/73; A63F 13/92; G07F 17/3244; A63F 2300/407

(57) ABSTRACT

Systems and methods are disclosed for interactive gaming. The system includes a messaging application; a plurality of animation objects, each having a receiver; a mapping store to provide mapping action for the plurality of animation objects during a chatting game; a messaging graphics renderer to provide animation for the animation objects; and a transmitter coupled to the messaging application.

### BACKGROUND OF THE INVENTION

The present invention relates generally to a method, apparatus, and computer instructions for processing, initiating, and displaying animations and games within instant messaging session.

Instant messaging is an online chat medium, allowing users to communicate with each other and to collaborate in real-time over a network data processing system. Instant messaging is commonly used over the Internet. Instant messaging applications monitor and report the status of users that have established each other as online contacts. This information is typically presented to a user in a window. Instant messaging applications also are often used by users conducting personal and business communications. By utilizing instant messaging, business users can view each other's availability and initiate a text conversation with colleagues or customers when a desired contact becomes available. Millions of users communicate using instant messaging systems every day. With instant messaging becoming an important part of both personal and business communication tools, interactive animation and graphics rendering functionality and usability enhancements are important to the continued success of this type of communication tool.

### SUMMARY

Systems and methods are disclosed for initiating and invoking interactive games or mini application within instant messaging session. The system includes a messaging application; a plurality of animation or graphics objects, each having a receiver; a mapping store to provide mapping action for the plurality of game animation objects or graphics application objects during a message chatting session; a messaging graphics renderer to provide animation/graphics for the animation/graphics objects; and a transmitter coupled to the messaging application. This invention is to expand the instant messaging chat session to provide interactive game or other activities while maintaining the instant messaging chat session.

Advantages of the system include the extra functionalities such as animated games or other interactive activities while instant messaging participants maintain the on-going conversation. The invention also provide more control for the instant messaging application provider to keep the added games or applications within the realm of the instant messaging conversation framework.

### BRIEF DESCRIPTION OF THE DRAWINGS

FIG. 1 shows an exemplary PC (Personal Computer) or mobile device interactive messaging software modules running on.

FIG. 2 shows an exemplary interactive animation system communicating with PCs and mobile devices over the internet cloud.

FIG. 3 shows exemplary initiating steps to start the selection of animated (mini) game on the mobile device within the interactive chat session of the messaging or chatting app.

FIG. 4 shows exemplary selection menu for animated (mini) game overlaid on top of the mobile device from the messaging or chatting app.

FIG. 5 shows exemplary animated (mini) game playing overlaid below the messaging chatting threaded area within the messaging or chatting app on the mobile device.

FIG. 6 shows exemplary animated (mini) game playing overlaid above the messaging chatting threaded area within the messaging or chatting app on the mobile device.

FIGS. 7 and 8 show steps of the software processing flow to initiate the within chat session animated game and selection process to start up the interactive game.

FIG. 9 shows an exemplary table for one of the interactive game downloaded bundled with a pair of Interactive Game Characters.

### DETAILED DESCRIPTION

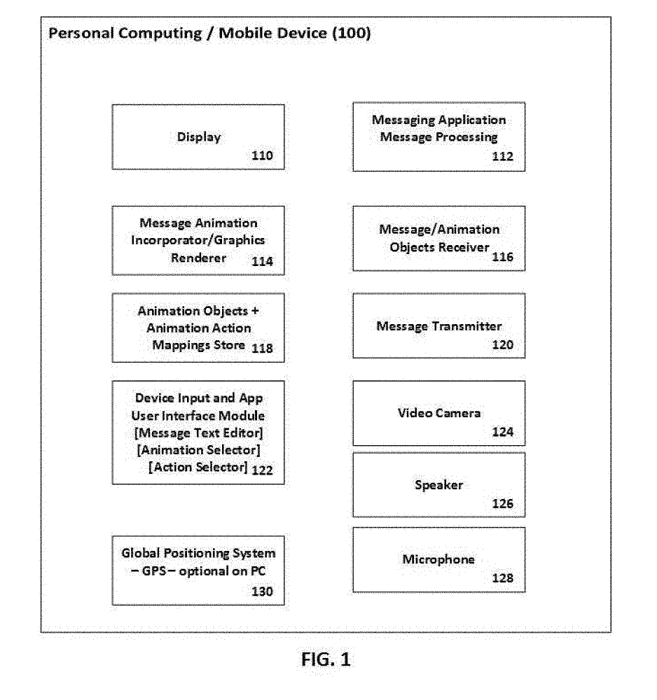

FIG. 1 shows an exemplary PC or mobile device/system running by various software modules which may control some of the hardware of the system. The PC/mobile device 100 includes a display module 110 for graphics display. The system also includes a messaging application message processing module 112. The message application is supported by a message animation incorporator and/or graphics renderer 114 to render the animation/graphics objects store these objects in the animation object and animation action mappings store 118. The message/animation objects are transmitted and received through data communications to and from the device system are supported by message object receiver 116 and transmitter 120, respectively. The system also uses a device input 122 such as application user interface module (e.g. message text editor, animation selector, and action selector). The system also includes video camera 124 to capture live photo, speaker 126 to transmit live voice, and microphone 128 to listen audio feed.

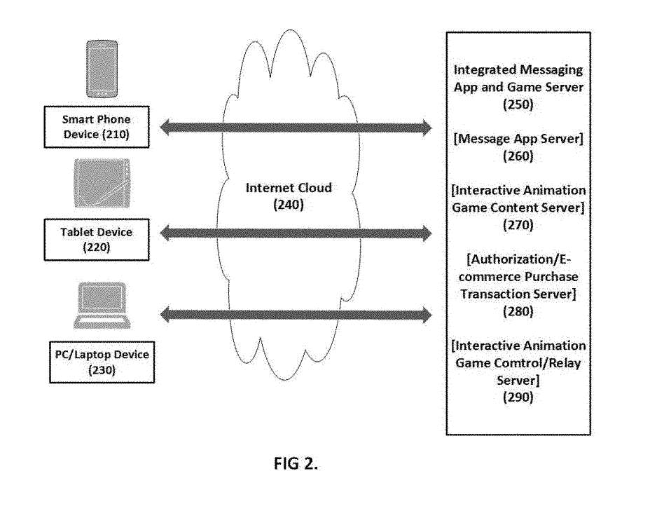

FIG. 2 shows detailed components that are used in the interactive animation system communicating with PCs and mobile devices over the internet cloud. In this example, the interactive messaging app that can be initiated running on a smart phone device 210, a tablet device 220 or a PC such as a laptop computer 230 communicates over the Internet cloud 240 to a set of integrated message app and game servers 250. The integrated set of servers 250 includes a messaging app server 260, interactive game content server 270, authorization/E-commerce purchase transaction server 280, and interactive animation game control/relay servers.

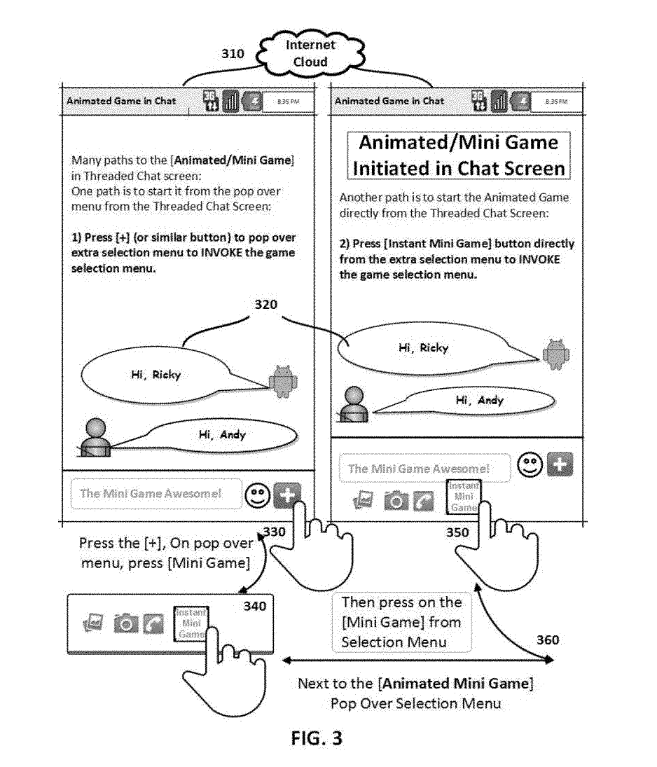

FIG. 3 shows an interactive messaging session between two participants on two mobile devices using the same messaging application communicating with each other over the internet cloud 310. In this example, during an interactive messaging session 320, one participant starts the pop over menu selection by pressing the [+] “more” button 330 on the lower menu/text bar area, and the pop over menu then provides the selections of the [mini game] (or similar icon) button 340 to start up the [mini game] selection page 360. The other participant at the different location with the same messaging app on a different mobile device may also press the [mini game] (or similar icon) button 350 directly to initiate the [mini game] menu selection page 360.

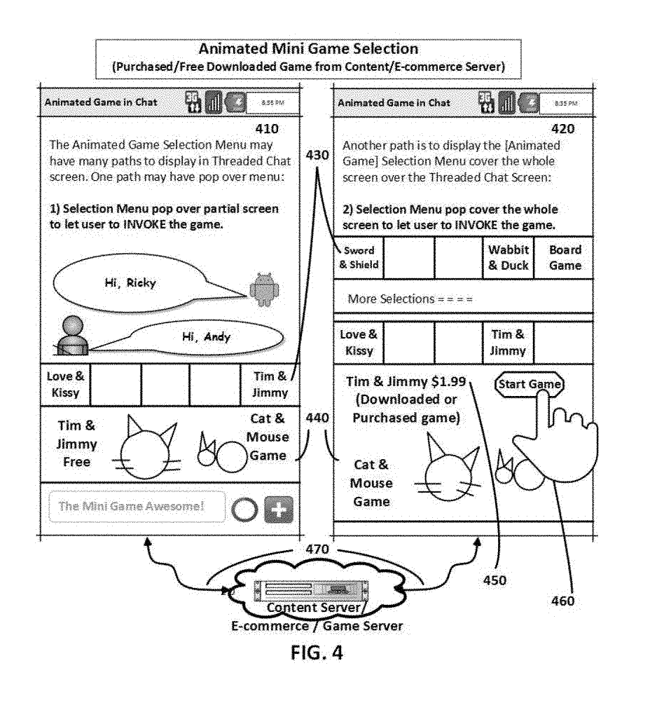

FIG. 4 shows that the initiated game selection menu by the participant user of an interactive messaging session may cover partially the conversation area 410. The initiated game selection menu may also pop over to cover the entire interactive session screen 420. The main menu selection shows the list of game title on the top 430. The detailed description of the highlighted game appears below the menu selection bar to provide more detailed content of the game 440 as well as possible purchase price 450 for the game. When the participant user pressed the [Start Game] of the selected button 460, the game initiation message is then sent to Content/E-commerce/Game server and relayed to message to the other participant 470.

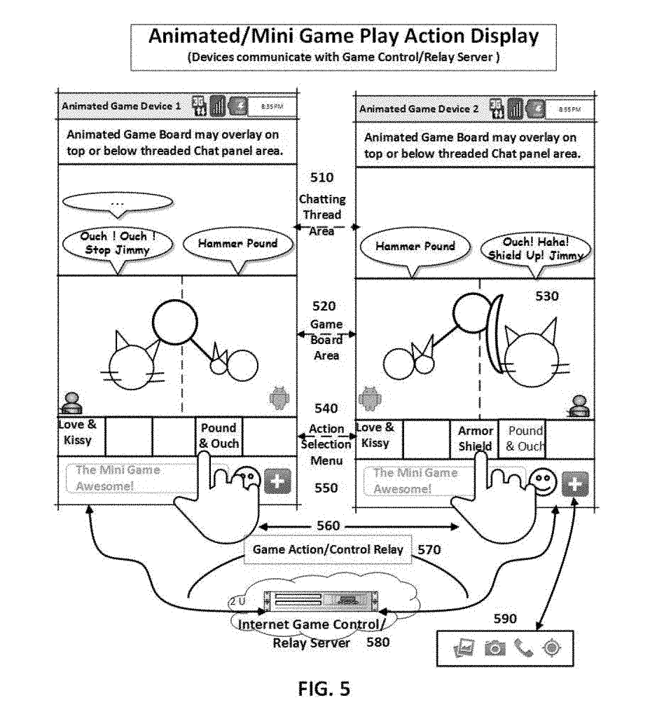

FIG. 5 shows that the interactive game starts with the game board rendering area below the messaging thread area on the device with four main functional areas: (1) Interactive messaging/chatting thread area 510 still maintains the on-going messaging conversation while the game is in play. (2) The game board area renders the interactive game contents 520. The chat (speech) bubble also shows the pointer (tail) pointing down to the game boards area or directly top of the action FIG. 530 (instead of the both sides) to have the effect as the classic comics strip looks. (3) The action selection menu area provides the action selection to act or react for the game figure action 540. (4) The messaging text input area still provides the conversation input mechanism 550. The action pressed by the game participant 560 sends the game action/control messages through internet 570 to the game control/relay server that coordinates between the participating game devices 580. Other common instant messaging app functionalities such as imaging, camera, phone call, and GPS (global positioning system) can still work together with all the interactive game 590.

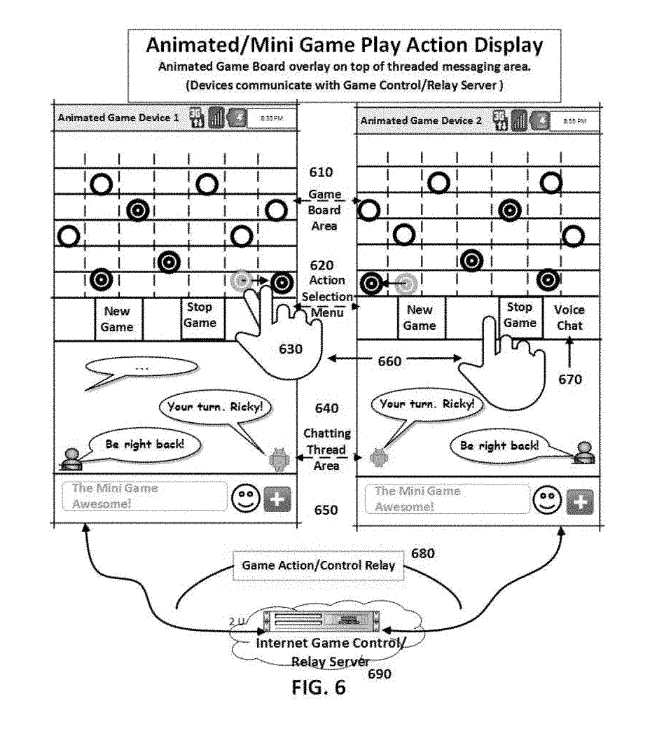

FIG. 6 shows that the interactive game starts with the game board rendering area above the messaging thread area on the device with similar four main functional areas. (1) The game board area renders the interactive game contents 610. The interactive animation game board renders objects have mirroring effects on opposite devices. However, some board games may render the same graphics on different devices. (2) The action selection menu area provides the action selection to act or react for the game board action 620. The game board area also provides the certain action as the finger swiping through board area to indicate moving action 630. (3) Interactive messaging/chatting thread area 640 still maintains the on-going messaging conversation while the game is in play. (4) The messaging text input area also provides the conversation input mechanism 650. The action pressed by the game participants 660 sends the game action/control messages, or the voice chat message 670, through internet 680 to the game control/relay server 680 that coordinates between the participating devices.

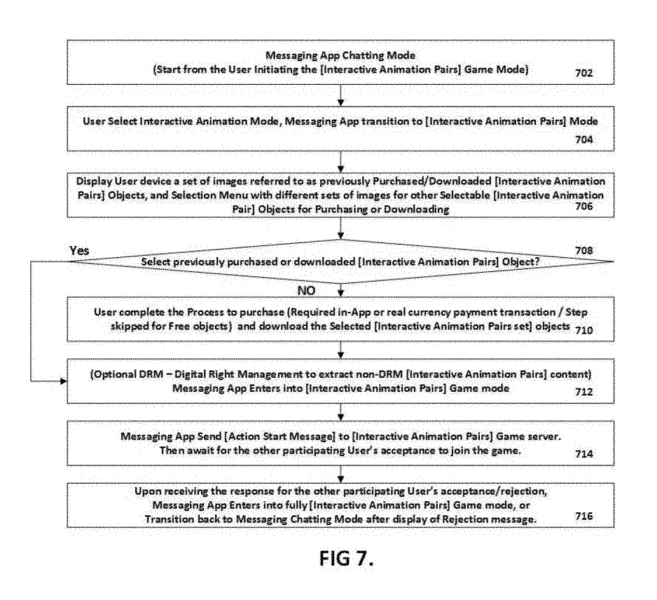

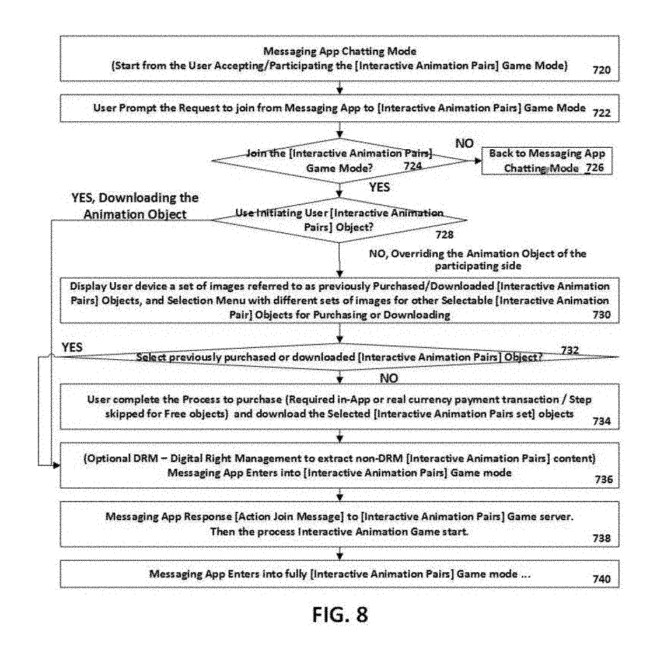

FIGS. 7 and 8 show exemplary program flows for messaging or chatting application within an interactive messaging session to initiate the interactive animation/game. Initially, the process is started by the participant user initiating within the messing application chatting session to start an interactive (paired) animation game mode (702). The user selects interactive animation mode and the messaging app transitions to the interactive (paired) animation/min game mode (704). The process displays on the user device a set of images/texts referred to as previously purchased or downloaded (interactive animation games) objects, and the process also displays a selection menu with different sets of images/texts for selectable interactive (paired) animation game objects for purchasing or downloading (706). The process then checks if the user selects a previously purchased or downloaded interactive (paired) animation game object in (708). If not already purchased or downloaded game, the user completes the process to optionally purchase (non-free) game with an in-app or currency payment transaction and downloads the selected interactive animation game objects (710). From 708 or 710, the process applies an optional digital rights management (DRM) to extract non-DRM interactive (paired) animation game content, and the messaging app enters into an interactive animation game mode (712). Next, the messaging app sends an action start message to the interactive animation (paired) game server and waits for the other participating user to join the game (714). Upon receiving the response from the other participating user's acceptance or rejection, the messaging app enters into a game mode with the interactive (paired) animation game, or the messaging app transitions back to the messaging chatting mode after displaying a reject message (716).

FIG. 8 shows the messaging app chatting mode is entered from the user acceptance or participation in the interactive (paired) animation game mode (720). Next, the user requests the request to join the messaging app to the interactive (paired) animation game mode (722). The process checks f the user wishes to join the interactive paired game mode (724) and if not, the process loops back to the messaging app chatting mode (726) and otherwise the process checks if the user has initiated the user interactive (paired) animation game object (728). If not, the process displays on the user device a set of images previously purchased or downloaded interactive (paired) animation game objects and selection menu with various images for selectable interactive (paired) animation game objects for purchasing or downloading (730). The process then checks if the user has selected the previously purchased or downloaded interactive (paired) animation game object (732), and if not, prompts the user to complete the purchasing process with an in-app purchase or currency payment transaction and allows the user to download the selected objects (734). From 728, 732 or 734, the process performs an optional digital rights management (DRM) function to extract non-DRM interactive (paired) animation game content and the messaging app enters into an interactive (paired) animation game mode (736). The messaging application responds with an action join message to the interactive (paired) animation game server and then starts the interactive animation game (738). Once the game starts, the messaging application enters into the fully interactive (paired) animation game mode (740).

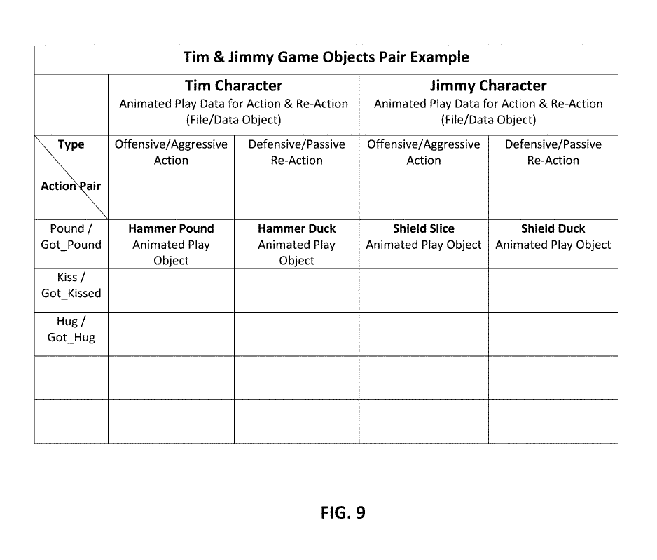

As shown in the following FIG. 9, one of the interactive game downloaded are bundled with pair of Interactive Game Characters. Each character has a set of actions can perform during the game play session. These play actions graphics are achieved by the set of Animated Play data objects—these file/data objects can be animated GIF (or equivalent APNG, WebM type), short looping video, or set of graphics rendering instructions to perform these actions. The different type of action and re-action is also performed automatically such as auto defensive ducking. The action can also be done by swiping the action object on the touch screen or by pushing a designated action button area.

The invention may be implemented in hardware, firmware or software, or a combination of the three. Preferably the invention is implemented in a computer program executed on a programmable computer having a processor, a data storage system, volatile and non-volatile memory and/or storage elements, at least one input device and at least one output device.

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

What is claimed is:

1. A system for interactive gaming, comprising:
a messaging application;
a game server;
a plurality of animation objects, each having a receiver;
a mapping store to provide mapping action for the plurality of animation objects during a chatting game;
a messaging graphics renderer to provide animation for the animation objects; and
a transmitter coupled to the messaging application and the game server.

2. The system of claim 1, comprising a messaging text editor.

3. The system of claim 1, comprising an animation selector.

4. The system of claim 3, comprising an action selector.

5. The system of claim 1, comprising a digital rights management unit to authorize the animation object.

6. The system of claim 1, comprising a store to sell the animation object for downloading.

7. The system of claim 1, wherein the messaging application responds to an action join message to the game server to start an interactive animation game using the messaging application.

8. The system of claim 1, wherein the messaging application enters a chatting mode when initiated by a user.

9. The system of claim 8, wherein the user selects a predetermined interactive animation mode.

10. The system of claim 1, wherein the messaging application sends an action start message to the game server and waits for a participating user to join a game and upon receiving the participating user's acceptance or rejection, the messaging app enters into a game mode with an interactive (paired) animation games object.

11. The system of claim 1, wherein during an interactive messaging session, one participant starts a pop over menu selection that provides selections to start up a game selection page, wherein another participant at a different location with the same messaging app on a different mobile device initiates a game menu selection.

12. The system of claim 1, wherein game participants take action to send game action/control messages through the internet to a game control/relay server that coordinates participating game devices.

13. The system of claim 1, comprising:
an interactive game including a game board rendering area below a messaging thread area with an Interactive messaging/chatting thread area to maintain on-going messaging conversation while the game is in play;
a game board area rendering interactive game contents with a chat (speech) bubble showing a pointer (tail) pointing down to the game board area or directly top of an action figure;
an action selection menu area providing an action selection to act or react to the game figure action; and
a messaging text input area.

14. The system of claim 1, comprising an interactive game having a game board rendering area above a messaging thread area on the device with four functional areas including (1) an interactive animation game board that renders objects have mirroring effects on opposite devices, (2) an action selection menu area that provides the action selection to act or react to the game board action, (3) an interactive messaging/chatting thread area that maintains on-going messaging conversation while the game is in play, and (4) a messaging text input area, where actions pressed by the game participants send game action/control messages through internet to a game control/relay server that coordinates between the participating game devices.

15. A method for playing a game, comprising
initiating a game mode using a messaging app chatting mode;
selecting an interactive animation mode and causing the messaging app to an interactive animation pair mode with a remote messaging app;
starting a game on a game server and waiting for the remote messaging app to join the game, and
entering into an interactive animation pair mode.

16. The method of claim 15, comprising displaying images for a purchased animation object.

11. The method of claim 15, comprising checking a digital rights management unit and authorizing an animation object.

18. The method of claim 15, comprising transitioning to a messaging chatting mode if the remote messaging app rejects a request from the messaging app.

19. The method of claim 15, comprising purchasing and downloading an animation object.

20. The method of claim 15, comprising operating an interactive game having a game board rendering area below a messaging thread area with an Interactive messaging/chatting thread area to maintain on-going messaging conversation while the game is in play.
